(19) United States
(12) Patent Application Publication
(10) Pub. No.: US 2004/0260004 A1
(43) Pub. Date: Dec. 23, 2004

(54) Resin-bonded graphite material, method for the production of a resin bonded graphite material and use thereof

(76) Inventors: Bettina Hubner, Munzenberg (DE); Rainer Sperling, Biebertal (DE); Klaus-Georg Tontsch, Giessen (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/495,119

(22) PCT Filed: Nov. 19, 2002
(86) PCT No.: PCT/EP02/12953

(30) Foreign Application Priority Data
Nov. 19, 2001 (DE) 10156320.5

(51) Int. Cl. C04B 35/00; B27N 3/00; C08K 3/04

(52) U.S. Cl. 524/495; 264/109; 264/122; 264/140; 264/105

(57) ABSTRACT

A resin bonded graphite material which is especially suitable for use as an electric contact, and a method for the production of this resin bonded graphite material. According to the invention, the resin-bonded graphite material if formed from a mixture of carbon black containing electro-graphite with a unburned graphite content of R_{G} wherein R_{G}≧30 percent by weight, electro-graphite free of carbon black as well as binding agents. The material has a specific electrical resistance W_{spec} wherein W_{spec}≧3500 μΩm, and use of the resin bonded graphite material as an electrical contact makes possible substantial exclusion of radio interference.

The invention refers to a resin-bonded graphite material, designated in particular for an electrical contact. In addition, the invention refers to a process for the manufacture of a resin-bonded graphite material, in particular for an electrical contact material. Finally, the invention refers to the use of a resin-bonded graphite material.

Resin-bonded graphite materials, carbon graphite materials, electro-graphite and graphite with metal additives such as copper and silver are used for carbon brushes, in particular small carbon brushes, just to name a few examples. The carbon graphite materials in particular are used with universal motors for household appliances as they distinguish themselves through their versatile usage for special troubleshooting purposes. There is also good commutation, low radio interference, longevity and utilization options with high mechanical and electrical loads. Short circuit currents can be limited and the inner resistance of sources of interference can be increased through the use of the highest-impedance carbon brush material possible. Appropriate carbon graphite materials for this have a specific electrical resistance of up to 2400 μΩm (see “Data Sheet Schunk Kohlenstofftechnik GmbH, Carbon Brushes, Materials Physical Values, L-Materials: Carbon Graphite 01-13/14-99”).

Regardless of the high-impedance carbon brush material that has been used up to now, it is also necessary to impregnate the carbon brushes in order to lower radio interference during the useful life of the carbon brush, in addition to the improved operation. Suppressors such as throttles or coils continue to be integrated.

The present invention is based on the problem of further developing a resin-bonded graphite material of the above-mentioned type such that radio interferences are excluded or nearly excluded during its use as an electrical contact without requiring further measures in principal such as impregnation.

According to the invention the problem is essentially solved with a resin-bonded graphite material in that the resin bonded graphite material consists of a hardened mixture of carbon black electro-graphite with a carbon black content of R_{G} with R_{G}≧30 percent by weight free of carbon black electro-graphite as well as binding agents, and has a specific electrical resistance W_{spec} whereby W_{spec}≧3500 μΩm. At least one additive such as a solid lubricant in form of, for example MoS₂ and/or WS₂ and/or an abrasive additive such as SiC and/or Al₂O₃ can be added to the mixture.

The carbon black free electro-graphite could especially be a carbon black free electro-graphite recycling material. Cartridge graphite, for example, could be used as the carbon 9 black containing electro-graphite.

Independent of this, each source product should be a carbon black free or a carbon black containing raw material that is combined with binding agents and then ignited, graphitized, and ground up.

It is also provided that the carbon black containing electro-graphite has a specific electrical resistance W_{spec} with <3500 μΩm≧40 μΩm.

Apart from this the electro-graphite source substances U 30 should be isotropic, meaning that they have a specific electrical resistance that is direction independent.

The carbon black containing electro-graphite as well as the carbon black free electro-graphite should have a kernel size d₅₀ of 20 μm≦d₅₀≦40 μm. The figure d₅₀ in this means that 50% of the ground raw material falls through a sieve of the predetermined mesh size.

A synthetic powder resin such as a synthetic plastic, in particular Duroplast, is used as the binding agent. Preferably the binding agent is a powdered resin dissolved in a solvent or a solvent free liquid resin.

In addition the binding agent in the form of a liquid resin and/or of a powdered resin dissolved in a solvent should have a glass conversion temperature T₀ of 50°≦T₀≦250° C. Another characteristic value of these resins is their viscosity V at room temperature wherein 10 cP≦V≦6000 cP.

The mixture itself should have 15-75 parts by weight of the carbon black containing electro-graphite, 15-75 parts by weight of carbon black free electro-graphite, 0-10 parts by weight solid lubricants, 0-1 weight proportion of an abrasive additive, wherein 15-35 parts by weight bonding agent is added to the solid materials.

It should be noted that the noted parts by weight of the raw materials, i.e. of the carbon black free and the carbon black containing electro-graphite and—if applicable—the additional additives total 100 parts by weight to which the parts by weight of the binding agent of 15-35 are added, which are in reference to the 100 parts by weight of the raw materials.

Based on the mixture according to the invention consisting of carbon black containing electro-graphite, unburned fine-grained carbon containing electro-graphite, in particular electro-graphite recycling material, and liquid binding agents, the result is a resin-bonded graphite material with a specific electrical resistance W_{spec}>3500 μΩm, especially up to 10,000 μΩm or higher. Thus, one can speak almost of an insulator without any negative influence on electrical conductivity.

Because of that there are advantages, in particular concerning radio interference, so that expensive suppressors such as throttles or coils can be avoided. It is also unnecessary to impregnate the material, which is necessary at least according to the state of the art. This material is used with a small engine power (<400 watts) and preferably 220-250 V voltage, in order to keep the electrical current small. In an operation of this engine power range no high temperatures occur at the carbon brush as they do with traditional materials. In addition, the useful life and the wear of the carbon brush is comparable with traditional materials.

A process for the manufacture of a resin-bonded graphite material, in particular for use as an electrical contact material, is essentially described with the following process steps:

Mixing of carbon black containing electro-graphite with a carbon black content R_{G} wherein R_{G}<30 percent by weight, burned carbon free, small kernel electro-graphite with a specific resistance value W_{spec} of 8 μΩm≦W_{spec}≦30 μΩm and a liquid binding agent at a temperature T₁,

Grinding of the mixture,

Pressurizing the ground-up mixture to a pellet and

subsequent hardening.

In particular, the carbon black containing electro graphite, the carbon black free small kernel electro-graphite and the liquid binding agent such as liquid resin are mixed at room temperature. This mixture is then ground to a kernel size d₅₀ wherein 50 μm≦d₅₀≦150 μm. The ground mixture is then exposed to a pressure of between 1000 and 2000 kp/cm². The pellet can than be hardened over a period of t of 10 hours≦1 ≦20 hours with a final temperature T at 180° C.≦T≦250° C.

A high specific electrical resistance of the resin-bonded graphite material according to the invention is achieved when 15-75 parts by weight of carbon black containing electro-graphite, 15-75 parts by weight of carbon black free small kernel electro-graphite and 15-35 parts by weight of binding agents are mixed, wherein preferably 0-10 parts by weight of solid lubricant and/or 0-1 weight proportion of abrasive additive are added to the mixture.

Carbon black free electro-graphite recycling material can be used as the carbon black free electro-graphite and/or cartridge graphite can be used as the carbon black containing electro-graphite. Powder resin dissolved in a solvent or solvent-free liquid resin can be used as the binding agent, wherein as the binding agent one that is based upon a synthetic a material such as epoxy resin or phenolic resin should be used. E 0 If a liquid binding agent is used, it should have a glass conversion temperature T_{G} with 50° Celsius≦T_{G}≦250° C. and/or at room temperature a viscosity V of 10 cP≦V≦6000 cP,

The invention especially distinguishes itself by the fact that the resin-bonded graphite material is used as material for a carbon brush or an abrasive ring.

Additional details, advantages and characteristics of the invention result not only from the claims and the characteristics depicted there—for themselves and/or in combination—but also from at least the following description of examples.

### EXAMPLE 1

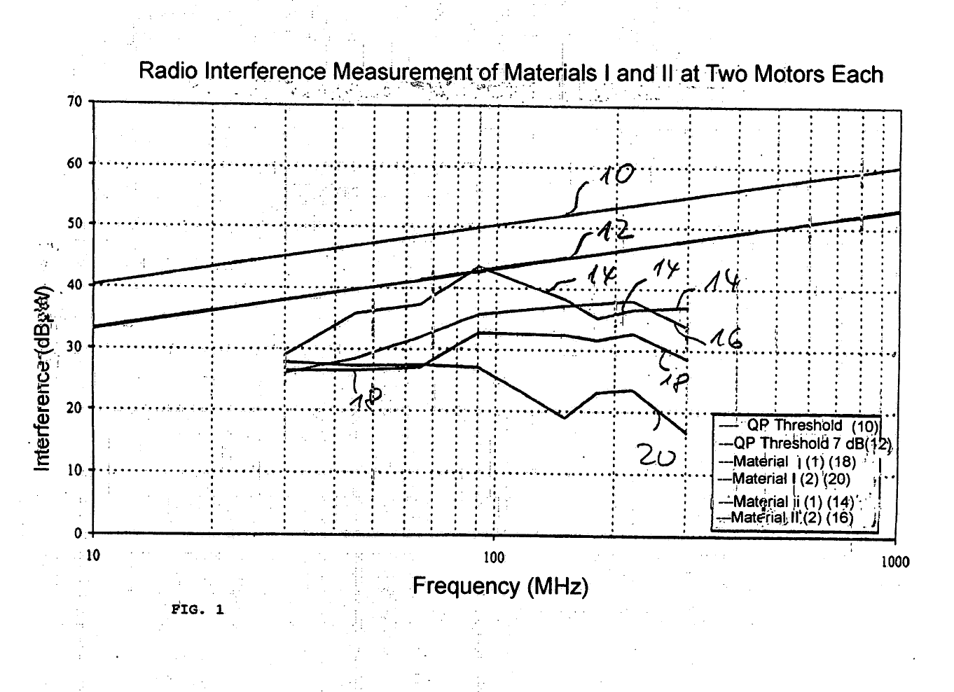

Fifty parts by weight of carbon black containing electro-graphite with a carbon black content of 50 percent by weight, a specific electrical resistance W_{spec} of approximately 100 μΩm and a kernel size d₅₀ of 30 μm with 50 parts by weight of burned carbon free small kernel electro-graphite recycling material with a specific electrical resistance W_{spec} of 20 μΩm and a kernel size d₅₀ of 30 μm were mixed with 25 parts by weight of a powder resin dissolved in a solvent in the form of an epoxy resin, in a sigma kneader at room temperature for the production of a carbon brush designated for small electrical engines. The finished mixture is then ground to a kernel size d₅₀ of 90 μm and pressurized with a specific pressure of 1500 kp/cm². The pellets were then subjected to a 15 hour hardening cycle with a final temperate of 200° C. The pellets had a specific electrical resistance W_{spec} of 8000 μΩm. The carbon brushes produced from these pellets were then compared in comparison measurements with carbon brushes made from traditional resin-bonded carbon graphite materials with a specific electrical resistance W_{spec} of 600 μΩm. In this, radio interference measurements were performed at two electrical motors. The results can be seen in FIG. 1.

The graphic designated with the reference number 10 in the only drawing corresponds to the threshold of the radio z interference gauge, whereas the straight line with the reference number 12 is the threshold reduced by 7 dB.

The curves 14, 16 were measured at two motors that were equipped with carbon brushes made from the traditional carbon brush material. The measurement curves 18, 20 are the results of the same motors, equipped, however, with the carbon brushes made from the material according to the invention, which had a specific electrical resistance of 8000 μΩm. A significant reduction in radio interference is apparent with the material according to the invention.

### EXAMPLE 2

Forty parts by weight of carbon black containing electro-graphite with a carbon black content of 50 percent by weight, a specific electrical resistance W_{spec} of approximately 100 μΩm and a kernel size d₅₀ of 30 μm with 60 parts by weight of burned carbon free small kernel electro-graphite recycling material with a specific electrical resistance W_{spec} of 20 μΩm and a kernel size d₅₀ of 30 μm were mixed with 25 parts by weight of a powder resin dissolved in a solvent in the form of an epoxy resin, in a sigma kneader at room temperature, for the production of a carbon brush designated for small electrical engines. The finished mixture was then ground to a kernel size d₅₀ of 90 μm and pressurized with a specific pressure of 1500 kp/cm². The pellets were then subjected to a 15 hour hardening cycle with a final temperate of 200° C. The pellets had a specific electrical resistance W_{spec} of 5000 μΩm. The carbon brushes produced from these pellets were then compared in comparison measurements with traditional resin-bonded carbon graphite material with a specific electrical resistance W_{spec} of 600 μΩm. Radio interference measurements according to Example 1 showed a significant reduction in radio interference in comparison with the traditional brushes.

1. Resin-bonded graphite material, in particular designated for an electrical contact, characterized in that the resin-bonded graphite material comprises a mixture of carbon black containing electro-graphite with a unburned graphite content of R_{G} wherein R_{G}≧30 percent by weight free of carbon black electro-graphite, as well as binding agents, and has a specific electrical resistance W_{spec} wherein W_{spec}≧3500 μΩm.

2. Resin-bonded graphite material according to claim 1, characterized in that the rein-bonded graphite material has a specific resistance W_{spec} wherein 3500 μΩm≦W_{spec}≦15,000 μΩm.

3. Resin-bonded graphite material according to claim 1, characterized in that the resin bonded graphite material has a specific electrical resistance W_{spec} wherein W_{spec}≦10,000 μΩm.

4. Resin-bonded graphite material according to claim 1, characterized in that the mixture contains at least one solid lubricant such as MoS₂ and/or WS₂ and/or an abrasive additive such as SiC and/or Al₂O₃.

5. Resin-bonded graphite material according to claim 1, characterized in that the carbon black free electro-graphite consists of a carbon black free electro-graphite recycling material.

6. Resin-bonded graphite material according to claim 1, characterized in that the carbon black containing electro-graphite consists of cartridge graphite.

7. Resin-bonded graphite material according to claim 1, characterized in that the carbon black containing electro-graphite has a specific resistance W_{spec} wherein 3500 μΩm≧W_{spec}≧40 μΩm.

8. Resin-bonded graphite material according to claim 1, characterized in that the carbon black free electro-graphite has a specific electrical resistance of 8 μΩm≦W_{spec}≦30 1μΩm.

9. Resin-bonded graphite material according to claim 1, characterized in that the carbon black containing electro-graphite has a kernel size d₅₀ of 20 μm≦d₅₀≦50 μm.

10. Resin-bonded graphite material according to claim 1, characterized in that the carbon black free electro-graphite has a kernel size d₅₀ of 20 μm d₅₀≦50 μm.

11. Resin-bonded graphite material according to claim 1, characterized in that the carbon black containing and/or the carbon black free electro-graphite is isotropic in reference to the specific electrical a resistance.

12. Resin-bonded graphite material according to claim 1, characterized in that the binding agent is a synthetic powder resin, such as a synthetic plastic, in particular a Duroplast.

13. Resin-bonded graphite material according to claim 1, characterized in that the binding agent is a synthetic epoxy powder resin and/or a phenolic resin.

14. Resin-bonded graphite material according to claim 1, characterized in that the binding agent is a powder resin dissolved in a solvent and/or a solvent-free liquid resin.

15. Resin-bonded graphite material according to claim 1, characterized in that the carbon black containing electro-graphite and the carbon black free electro-graphite as well as its admixed solid lubricant—if applicable—and/or abrasive additive has a total of 100 parts by weight as raw material to which the binding agent with its weight proportion of 15 to 35 in reference to the 100 weight proportion of the raw material is added.

16. Resin-bonded graphite material according to claim 1, characterized in that the binding agent has a glass conversion temperature T_{G} wherein 50° C.≦T_{G}≦250° C.

17. Resin-bonded graphite material according to claim 1, characterized in that the binding agent has a viscosity V wherein 10 cP≦V≦6000 cP at room temperature.

18. Resin-bonded graphite material according to claim 1, characterized in that the mixture comprises 15 to 75 parts by weight of the carbon black containing electro-graphite, 15 to 75 parts by weight of the carbon black free electro-graphite, 0 to 10 parts by weight of the solid lubricant, 0 to 1 weight proportion of the abrasive additive, and 15 to 35 parts by weight of the binding agent.

19. Process for the manufacture of a resin-bonded graphite material, designated in particular as an electrical contact material, characterized by the following process steps:
Mixing of carbon black containing electro-graphite with a carbon black content R_{G} wherein R_{G}>30 percent by weight, burned carbon free small kernel electro-graphite with a specific resistance value W_{spec} of 8 μΩm≦W_{spec}≦30 μΩm and a liquid binding agent at a temperature T₁,
Grinding of the mixture to a kernel size of d₅₀ wherein 50 μm≦d₅₀150 μm,
Pressurizing the ground-up mixture and
Hardening of the ground mixture to a pellet.

20. Process according to claim 19, characterized in that the carbon black containing electro-graphite, the carbon black free electro-graphite and the binding agent are mixed at a temperature T₁ wherein T₁=room temperature.

21. Process according to claim 19, characterized in that a solid lubricant such as MoS₂ and/or WS₂ is added to the mixture.

22. Process according to claim 19, characterized in that an abrasive additive such as SiC and/or Al₂O₃ is added to the mixture.

23. Process according to claim 19, characterized in that the ground mixture is pressurized at a pressure of between 1000 and 2000 kp/cm².

24. Process according to claim 19, characterized in that the pellet is hardened over a period t of 10 hours≦t≦20 hours with a final temperature T₂ wherein 180° C.≦T₂≦250° C.

25. Process according to claim 19, characterized in that 15 to 75 parts by weight of the carbon black containing electro-graphite, 15 to 75 weight percentages of the carbon black free electro-graphite and 15 to 35 parts by weight of the binding agents are mixed.

26. Process according to claim 19, characterized in that 0 to 10 parts by weight of the solid lubricant are added to the mixture.

27. Process according to claim 19, characterized in that 0 to 1 weight proportion of the abrasive additive is added to the mixture.

28. Process according to claim 19, characterized in that carbon black free electro-graphite recycling material is used as the carbon black free electro-graphite.

29. Process according to claim 19, characterized in that cartridge graphite is used as the carbon black containing electro-graphite.

30. Process according to claim 19, characterized in that powder resin dissolved in a solvent is used as the binding agent.

31. Process according to claim 19, characterized in that a solvent-free liquid resin is used as the binding agent.

32. Process according to claim 19, characterized in that a synthetic plastic such as epoxy resin or phenolic resin is used as the binding agent.

33. Process according to claim 19, characterized in that a liquid binding agent having a glass conversion temperature T_{G} wherein 50° C.≦T_{G}≦250° C. is used.

34. Process according to claim 19, characterized in that a liquid binding agent having a viscosity V wherein 10 cP≦V≦6000 cP at room temperature is used.

35. Process according to claim 19, characterized in that a carbon black containing electro-graphite having a specific electrical resistance W_{spec} wherein 40 μΩm≦W_{spec}≦3500 μΩm is used.

36. Process according to claim 19, characterized in that a carbon black containing electro-graphite having a specific electrical resistance W_{spec} wherein W_{spec}≦2500 μΩm is used.

37. Process according to claim 19, characterized in that a carbon black free electro-graphite having a specific electrical resistance W_{spec} wherein 8 μm≦W_{spec}≦30 μΩm is used.

38. Process according to claim 19, characterized in that a carbon black free electro-graphite having a kernel size d₅₀ wherein 20 μm≦d₅₀≦150 μm is used.

39. Process according to claim 19, characterized in that a carbon black free electro-graphite having a small kernel size d₅₀ wherein 20 μm≦d₅₀≦50 μm is used.

40. Process according to claim 19, characterized in that a carbon black free electro-graphite and/or a carbon black containing electro-graphite is used whose specific electrical resistance is isotropic.

41. (canceled)
